(19) United States
(12) Patent Application Publication
(10) Pub. No.: US 2004/0097358 A1
(43) Pub. Date: May 20, 2004

(54) Filter

(76) Inventor: Thomas J. Hajek JR., Lockport, IL (US)

Correspondence Address: CATERPILLAR INC., 100 N.E. ADAMS STREET, PATENT DEPT., PEORIA, IL, 616296490

(21) Appl. No.: 10/300,109

(22) Filed: Nov. 20, 2002

(51) Int. Cl. B04B 1/04

(52) U.S. Cl. 494/37; 494/65; 494/68; 494/80

(57) ABSTRACT

A filter may have a housing with an inlet and an outlet. A shaft may be rotatably supported in the housing. A rotor may be attached to the shaft, the rotor having an inlet and an outlet. A plurality of members may be attached to the rotor, and a plurality of chambers may be defined in the rotor. The plurality of chambers are placed relative to the members to direct fluid in successive relation across the plurality of members as the fluid commutes between the inlet and the outlet of the rotor.

### TECHNICAL FIELD

This invention relates generally to a filter, and, more particularly to a filter having a rotating assembly.

### BACKGROUND

A filter is shown in U.S. Pat. No. 6,156,193 to Meinhold et al., having an issue date of Dec. 5, 2000, that includes a housing with a base or can and a cover. A shaft is disposed in the housing and mounted to the base and cover for rotation relative thereto. A bowl is attached to the shaft for rotation therewith, the bowl having a wall that defines a chamber. Fluid, having entrained debris therein, passes into the chamber as the bowl rotates with the shaft. As a consequence of the motion of the bowl, the liquid and debris moves radially outward toward an inner surface of the bowl wall. The fluid passes out of the chamber, while the debris collects on the inner surface of the wall of the chamber to be retained therein. The fluid flowing out of the chamber may then be directed into a drive element that is attached to the shaft. The motion of the fluid through the drive element causes the shaft and the bowl to rotate.

The filter described above has its drawbacks. When the angular velocity of the bowl decreases at shutdown, impacted debris collected on the inner surface of the bowl wall becomes dislodged, and may become entrained again in the fluid. This phenomenon is known as “clouding.” Typically, the fluid flow through the filter is still sufficient to carry at least some of the dislodged debris downstream of the chamber. Moreover, at start-up, the bowl will not immediately attain an angular velocity sufficient to collect the debris on the inner surface of the bowl wall. Consequently, further dislodged debris may be carried out of the bowl as the fluid initially passes through the filter.

Some of the debris carried from the chamber may become lodged in the drive element that is used to rotate the shaft and bowl. Over time, the build-up of debris in the drive element may limit the angular velocity of the bowl, preventing debris from being effectively removed from the fluid. It is possible that the drive element may eventually become so clogged that the bowl fails to rotate at all.

Moreover, the debris may be carried downstream of the filter altogether, and may collect in other parts of the system to which the filter is attached. The collection of debris in other parts of the system may decrease the longevity of those parts, and of the system as a whole.

Another problem associated with spin filters is that the inner rotating structure includes numerous radially spaced chambers to collect debris being flung radially outward. These types of filters are often expensive and undesirably restrict fluid flow. For example, U.S. Pat. No. 6,261,455 issued to Brown et al., having an issue date of Jul. 17, 2001, discloses a spin filter having a rotating inner structure made of numerous overlayed and specifically shaped plates.

The present invention is directed to overcoming one or more of the problems or disadvantages associated with the prior art.

### SUMMARY

A filter may have a housing with an inlet and an outlet. A shaft may be rotatably supported in the housing. A rotor may be attached to the shaft, the rotor having an inlet and an outlet. A plurality of members may be attached to the rotor, and a plurality of chambers may be defined in the rotor. The plurality of chambers are placed relative to the members to direct fluid in successive relation across the plurality of members as the fluid commutes between the inlet and the outlet of the rotor.

A filter may alternatively include a housing including an inlet and first and second outlets, and a rotor rotatably mounted in the housing. The rotor may include an inlet, a first outlet, and a second outlet spaced from the first outlet. A plurality of members may be disposed in and attached to the rotor.

A method of separating and filtering fluids may also be provided. The method may include passing a mixture of fluids over a plurality of members and rotating the plurality of members. The method may further include withdrawing a first fluid through a first outlet and withdrawing a second fluid through a second outlet spaced from the first outlet. The methods may also include retaining debris carried by the fluids.

### BRIEF DESCRIPTION OF THE DRAWINGS

FIG. 1 is an axial cross-sectional view of an embodiment of a filter in combination with a diagrammatic view of a fluid system;

FIG. 2 is a radial cross-sectional view of the filter of FIG. 1, taken along line 2-2 in FIG. 1;

FIG. 3 is a radial cross-sectional view of the filter of FIG. 1, taken along line 3-3 in FIG. 3;

FIG. 4 is an axial cross-sectional view of another embodiment of a filter; and

FIG. 5 is a radial cross-sectional view of the filter of FIG. 4, taken along line 5-5 in FIG. 4.

### DETAILED DESCRIPTION

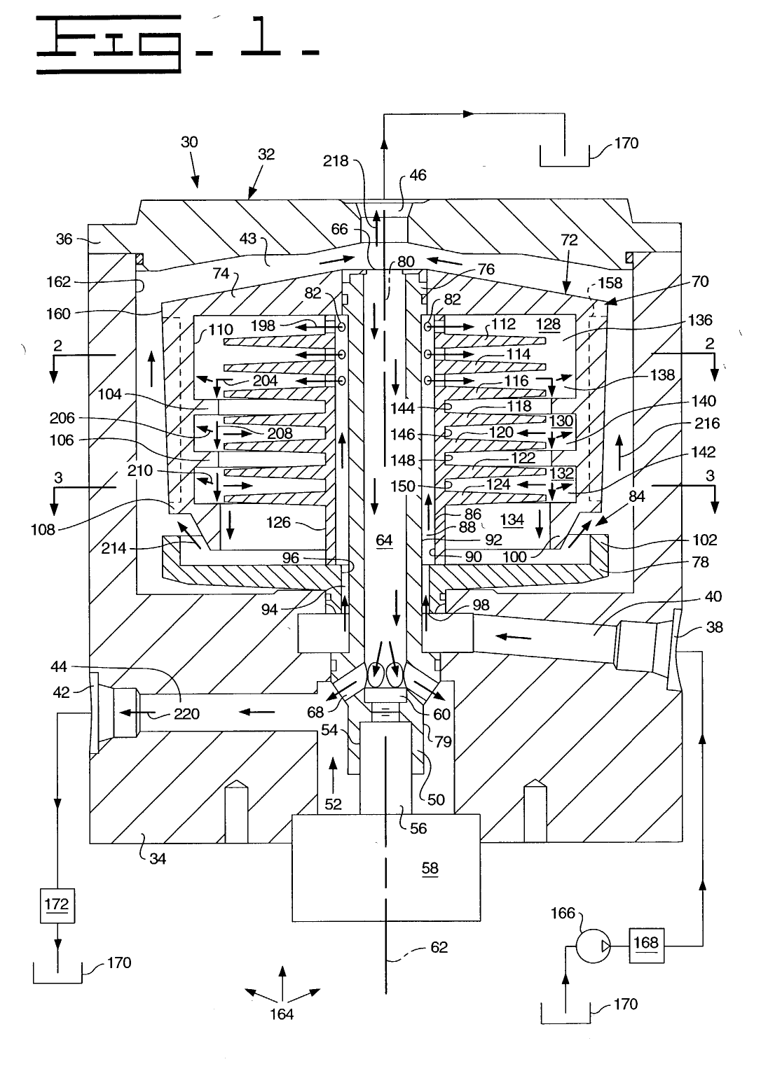

Referring to FIG. 1 of the drawings, an embodiment of a filter 30 may include a housing 32. The housing 32 may include a base or can 34 and a cover 36. The cover 36 may be attached to the base 34 using a threaded connection, for example. An O-ring (not shown) may be disposed between the cover 36 and the base 34 to limit leakage, although a metal-to-metal seal may be sufficient for some applications.

A housing inlet 38 and an associated passage 40 may be defined in the base 34, while a housing outlet 42 (and an associated passage 44) and a housing outlet 46 may be defined in the base 34 and the cover 36, respectively. The housing 32 may define a chamber 48 that may be in fluid communication with the inlet 38 (via passage 40) and outlets 42 (via the passage 44), 46.

A shaft 50 may be disposed in the housing 32 so as to extend in a cantilevered fashion into the chamber 48. In particular, the shaft 50 may be rotatably supported at a first end 52 to the base 34, for example, through the use of a bearing. The shaft 50 may have a receptacle 54 formed therein to mate with a shaft 56 of a drive 58, such as an electric motor or mechanical drive element, for example. The shaft 50 may be secured to the shaft 56 through the use of a bolt 60, as shown, or the receptacle 54 and the shaft 56 may be threaded instead. The drive 58 may rotate the shaft 50 about its axis of rotation 62.

The shaft 50 may define a passage 64 therethrough along its entire axial or longitudinal length between an open end 66 and the end 52. The open end 66 may be in fluid communication with the chamber 48. Fluid may pass out of the passage 64 through radial or transverse passages 68 formed in the end 52 of the shaft 50. The passages 68 may be in fluid communication with the housing outlet 42 via the outlet passage 44.

A rotor 70 may be attached to the shaft 50. The rotor 70 may include a shell 74, a core 76, and a bowl-shaped end plate 78. The core 76 may be attached to either or both of the shell 74 and the end plate 78, or the shell 74 and the end plate 78 may have walls formed on the facing surfaces thereof that cooperate with the ends of the core 76 to hold the core 76 in place. As a further alternative, the core 76 may not be secured or held by either of the shell 74 and the end plate 78, and may instead have radially inwardly directed tabs extending from an inner surface thereof, the tabs cooperating with the shaft 50 to hold the core 76 in its place and transmit the motion of the shaft 50 to the core 76.

As shown, the rotor 70 may be connected to the shaft 50 for rotation therewith about an axis of rotation 80. The shaft 50 thus acts as a means 79 for rotatably connecting the rotor 70 to the filter housing 32. As shown, the axis of rotation 80 of the rotor 70 coincides with the axis of rotation 62 of the shaft 50. It will be recognized that non-alignment or misalignment may occur between the axes 62, 80 while permitting the filter 30 to remove entrained debris from a fluid.

The rotor 70 may have a plurality of radially directed rotor inlets 82 and an annular rotor outlet 84. The rotor inlets 82 may be defined in a shaft-like section 86 of the core 76, and may be in fluid communication with a passage 88 defined by an inner surface 90 of the shaft-like section 86 and an outer surface 92 of the shaft 50. The passage 88 may be in fluid communication with the housing inlet passage 40 via a passage 94 defined by the outer surface 92 of the shaft 50 and a surface 96 of a central aperture 98 in the end plate 78 through which the shaft 50 is disposed. The rotor outlet 84 may be defined by an edge 100 of the shell 74 and a rim 102 of the end plate 78.

A plurality of radially extending members 104, 106, 108 may be attached to an inner surface 110 of the shell 74. A plurality of radially extending members or distribution plates 112, 114, 116, 118, 120, 122, 124 may be attached to an outer surface 126 of the shaft-like section 86 of the core 76. As shown, the radially extending members 112, 114, 116, 118, 120, 122, 124 are integral to the shaft-like section 86, although the radially extending members 112, 114, 116, 118, 120, 122, 124 may be separate.

As best seen in FIG. 1, the radially extending members 104, 106, 108, the inner surface 110 of the shell 74, and the end plate 78 may define a plurality of chambers 128, 130, 132, 134 into which the radially extending members 112, 114, 116, 118, 120, 122, 124 may depend. The radially extending members 104, 106, 108 and the chambers 128, 130, 132, 134 may also define a flow path 136, and in particular a serpentine flow path, between the rotor inlets 82 and the rotor outlet 84.

As also seen in FIG. 1, the radially extending members 104, 106, 108 in cooperation with the surface 110 and members 116, 118, 120, 122, 124 in cooperation with the surface 126 may define spaces 138, 140, 142, 144, 146, 148, 150 wherein debris may be retained during operation. Specifically, it is thought that the heaviest debris may be retained in the space 138 defined by the member 104 and the surface 110. As fluid flows along the flow path 136, additional entrained debris may be separated from the fluid and retained, with the heavier elements retained in the spaces 140, 142 defined by the members 106, 108 and the surface 110 and the lighter elements retained in the spaces 144, 146, 148, 150 defined by the members 116, 118, 120, 122, 124 and the surface 126. Debris that may remain entrained in the fluid may be retained in the end plate 78. The end plate 78 may also retain any debris that might be dislodged during removal of the shell 74 and/or core 76 during servicing.

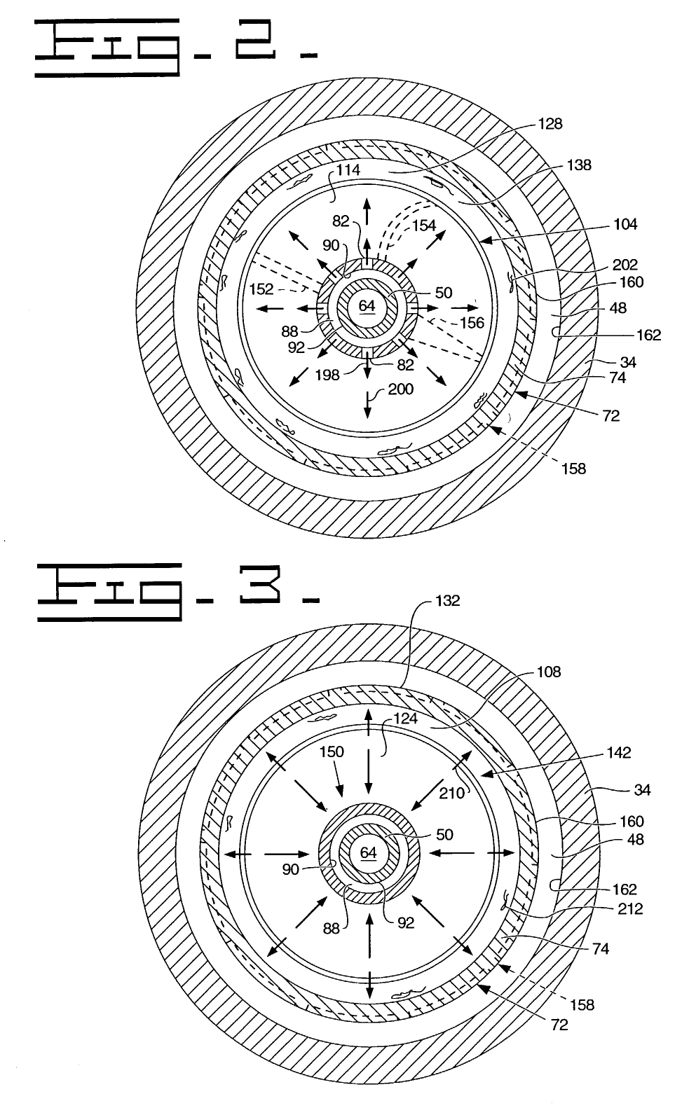

To enhance the movement of the fluid and entrained debris within the rotor housing 72, optional fins 152, 154, 156 may be attached to and/or between at least the radially extending members 112, 114, 116, as shown in dashed line in FIG. 2.

As shown, the fin 152 is straight, i.e., the fin 152 extends radially away from the surface 126 of the core 76 and is of generally uniform axial cross-section. By contrast, the fin 154 is curved, and the fin 156 is tapered, i.e., the fin 156 extends radially away from the surface 126 of the core 76 but is not of uniform axial cross-section. These fin shapes have been shown for illustration purposes only, and other fin shapes may be used. Moreover, a single fin may have sections that are of one shape (e.g., straight) and other sections that are of another shape (e.g., curved or tapered).

Different types of fins 152, 154, 156 have been shown attached to and/or between at least the radially extending members 112, 114, 116. Any combination of different types of fins 152, 154, 156 may be used, as may combinations of the fins 152, 154, 156 shown and other fin shapes that have not been shown. Alternatively, a single type of fin may be used in the rotor 70.

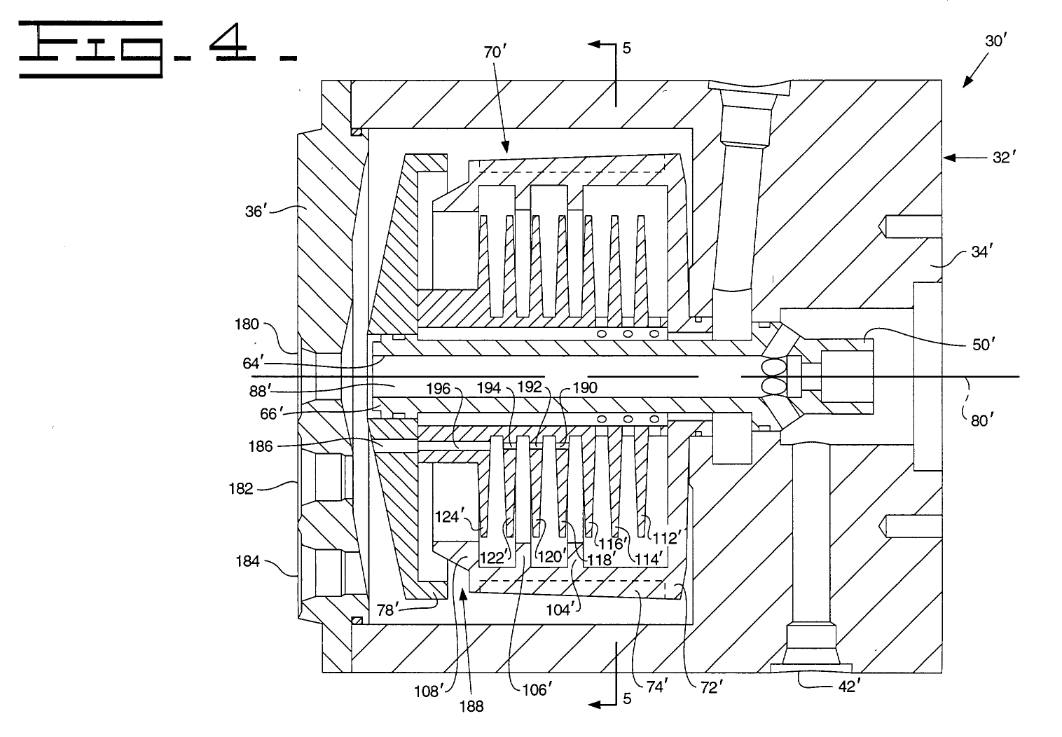

As shown in FIGS. 2 and 3, axially aligned fins 158 may also optionally be defined in an outer surface 160 of the shell 74 opposite the inner surface 110. The fins 158 are marked in dashed in line in the drawings. The fins 158 may cause rotational movement of the fluid in the chamber 48. The movement of fluid in the chamber 48 may cause further separation of entrained debris from the fluid passing through the chamber 48, which debris may be retained on an inner surface 162 of the housing 32.

Returning to FIG. 1, the filter 30 may be combined with a fluid system 164. The fluid system 164 may include a source of fluid flow, such as a hydraulic pump 166, which may direct fluid flow to a fluid circuit 168 and subsequently to a reservoir 170. As the fluid passes from the circuit 168 to the reservoir 170, the fluid may passes through the filter 30 and a filter 172. The filter 172 may be a cellulose filter of conventional design, and is optional.

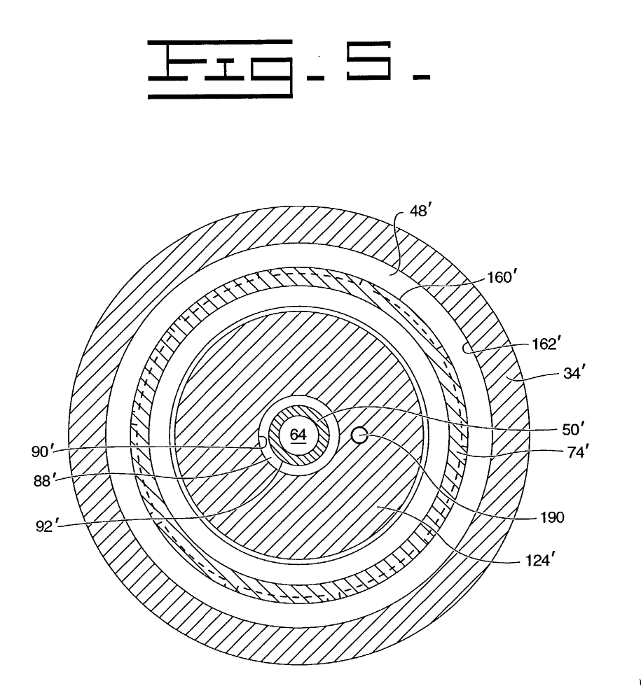

Referring now to FIG. 4, another embodiment of the filter 30′ is shown. The common elements between the filter 30 and the filter 30′ are numbered similarly, with those of the filter 30′ being indicated with a prime designation.

In the filter 30′ shown in FIGS. 4 and 5, the filter housing 32′ and the rotor 70′ may be adapted to remove entrained debris from a mixture of fluids of different densities and to separate the mixture of fluids into the constituent fluids. The shell 74′ may be attached to the base 34′ and the end plate 78′ may be attached to the end 66′ of the shaft 50′. The housing 32′ may also have a plurality of housing outlets 180, 182, 184 in the cover 36′ at different distances from the axis of rotation 80′ of the rotor 70′. The rotor 70′ may also have a plurality of rotor outlets 186, 188 disposed at different distances from the axis of rotation 80′. Further, the radially extending members 118′, 120′, 122′, 124′ may have at least one set, possibly more, of axially directed passages 190, 192, 194, 196 that may be in fluid communication with the rotor outlet 186, that may be aligned with the rotor outlet 186 so as to be at the same distance from the axis of rotation 80′, and that may be adapted to pass a lighter density fluid therethrough. Also, the filter 30′ may be oriented with the axis of rotation 80′ substantially horizontal such that gravity may enhance the separation of debris from fluid and fluids of different densities from each other.

### INDUSTRIAL APPLICABILITY

As shown in FIG. 1, the filter 30 (or 30′) may be used as a downstream filter in a lubrication system, for example. In such an application, the operation of the filter 30 may remove a substantial portion of the entrained debris before the fluid may be returned to the reservoir 170, thereby improving the life of the other components of the system 164. The filter 172, as shown in FIG. 1, is optional; the filter 30 may substantially remove entrained debris from a fluid and may separate a mixture of fluids into its constituent fluids.

During operation of the filter 30, a mixture of fluid and entrained debris may flow or pass from the pump 166 to into the housing inlet 38. The fluid may flow via the passages 40, 94, 88 to the rotor inlets 82, as shown by the arrows 198. The fluid may pass through the rotor inlets 82 and over the radially extending members 112, 114, 116 into the first chamber 128.

The drive 58 may cause the rotor 70 (and associated radially extending members 104, 106, 108, 112, 114, 116, 118, 120, 122, 124) to rotate at a high angular velocity. Again referring to FIGS. 2 and 3, the high angular velocity of the rotor 70 may cause the fluid passing through inlets 82 to be directed against the inner surface 110 of the shell 74, as shown by the arrows 200. A portion of the debris 202 entrained in the fluid may become separated from the fluid and may be retained in the space 138 defined by the radially extending member 104 and the inner surface 110. The portion of debris collected in the space 138 generally represents those debris elements that may have a higher density than the elements that remain entrained in the fluid. Some of the debris elements which may be less dense may separate in the first chamber 128, but the ingress of fluid through the inlets 82 and the turbulent mixing occurring in the chamber 128 may minimize the separation.

The fluid and the portion of the debris that may remain entrained in the fluid then may pass around the radially extending member 104 into the next chamber 130, as shown by arrows 204 in FIG. 1. Here, the rotational motion of the rotor 70 may again direct the fluid generally outwardly, as shown by arrows 206. Heavier debris elements may be retained in the space 140 defined by the radially extending member 106 and the inner surface 110. Lighter debris elements may be retained in the spaces 144, 146 between the radially extending elements 116, 118, 120. The fluid and any remaining entrained debris may pass around the radially extending member 106 into the chamber 132 as shown by arrows 208, wherein the fluid may move outward (as represented by arrows 210 in FIG. 3) and the debris 212 may be retained in spaces 148, 150. The fluid and any still remaining debris may be directed into the bowl-shaped end plate 78, and through the rotor outlet 84 into the chamber 48, as shown by arrows 214.

The optional fins 158 may cause the fluid and any entrained debris still remaining to spin within the chamber 48. Some further debris may be separated from the fluid in the chamber 48, and collect on the inner surface 162 of the housing 32. The fluid, with a substantial portion of the entrained debris removed therefrom, may pass from the chamber 48 (arrows 216) either directly through the housing outlet 46 (arrows 218) or, via passages 64, 168 and 44, through the outlet 42 (arrows 220).

Much of the operation of the filter 30′ may be substantially similar to that of the filter 30. That is, a mixture of fluids and entrained debris may pass through several chambers and around several radially extending members, and debris may be separated from the fluids. Moreover, as a further aspect of the operation of the filter 30′, rotational motion may be induced in the fluids as the fluid mixture passes through the filter 30′ and may cause the fluid mixture to separate. In particular, less dense fluids, including air, may migrate to a position closer to the axis of rotation 80′ while debris and liquids having higher densities may migrate to a position further from the axis of rotation 80′. The filter 30′ may have a system of passages 190, 192, 194, 196 disposed relatively closely to the axis of rotation 80′ to permit the less dense fluids to be pass therethrough. The less dense fluids may be withdrawn via a first rotor outlet 186 and then a housing outlet 180 disposed relatively closely to the axis of rotation 80′. Heavier fluids may be withdrawn via a rotor outlet 188 and a housing outlet 182, 184 disposed relatively further from the axis of rotation 80′.

The filter 30, 30′ is not limited to the application discussed above, but may be used in other fluid systems 164, such as systems using a circulating fluid to provide hydraulic power. Moreover, the filter 30, 30′ need not be in direct communication with the circuit 168, but may be placed in a side loop. Moreover, the filter 30, 30′ may be used as a pre-filter, disposed upstream of the circuit 168 so as to limit the debris entering the circuit 168 and lengthening the life of the circuit 168 It will be recognized that an upstream application may require attention to pressure gradients not thought to be as significant a concern in the downstream application discussed. Further, the filter 30′ may be used separate fluids of different densities and to return the fluids to separate applications, as required.

The filter 30, 30′ may substantially limit the effects of the “clouding” phenomenon. That is, as fluid passes through the filter 30, 30′, the fluid may travel along a lengthy, convoluted path. The convoluted path may provides an opportunity for any dislodged debris materials, which may become entrained when the angular velocity of the rotor 70, 70′ decreases, to fall out again before the fluid passes downstream of the filter 30, 30′. The filter 30′ may create stratification not only between the debris and a fluid mixture, but also within the fluid mixture itself, and may use the stratification to provide a multi-stream fluid output.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. The details of the structure may be varied substantially without departing from the spirit of the invention, and the exclusive use of all modifications which come within the scope of the appended claims is reserved.

Other aspects and features of the present invention can be obtained from a the drawings, the disclosure, and the appended claims.

What is claimed is:

1. A filter comprising:
a housing having an inlet and an outlet;
a shaft rotatably supported within said housing;
a rotor having an inlet and an outlet, said rotor being attached to said shaft;
a plurality of members attached to said rotor; and
a plurality of chambers defined by said rotor, said plurality of chambers being placed relative said members to direct fluid in successive relation across said plurality of members as the fluid commutes between said inlet and said outlet of said rotor.

2. The filter according to claim 1, wherein the plurality of members and the plurality of chambers define a serpentine flow path between the rotor and the shaft.

3. The filter according to claim 1, wherein:
the rotor includes a core and a shell with an inner surface disposed radially outward from the core;
the plurality of members are attached to the core and define with the core a first plurality of debris collection spaces; and
another plurality of radially extending members are attached to the shell and define with the inner surface a second plurality of debris collection spaces.

4. The filter according to claim 3, wherein:
the rotor inlet is defined in the core;
the shaft has an outer surface and the core has an inner surface, the inner surface of the core is spaced from the outer surface of the shaft to define a first passage therebetween in fluid communication with the housing inlet and the rotor inlet; and
the shaft includes a second passage therethrough in fluid communication with the rotor outlet and the housing outlet.

5. The filter according to claim 3, including a plurality of axially directed fins disposed on an outer surface of the shell opposite the inner surface.

6. The filter according to claim 1, including a plurality of fins attached to at least one of the plurality of members and of a fin-type selected from the group of fin-types consisting of straight, curved and tapered.

7. The filter according to claim 1, including a bowl-shaped end plate disposed adjacent the rotor outlet.

8. The filter according to claim 1, wherein:
the rotor has an axis of rotation,
the rotor outlet is at a first distance from the axis of rotation;
the housing has another outlet;
the rotor has another outlet at a second distance from the axis of rotation different than the first distance and in fluid communication with the another housing outlet.

9. The filter according to claim 8, wherein the axis of rotation is substantially vertical.

10. A filter comprising:
a housing including an inlet and first and second outlets;
a rotor rotatably mounted in the housing, including an inlet, a first outlet, and a second outlet spaced from the first outlet; and
a plurality of members disposed in and attached to the rotor.

11. The filter according to claim 10, wherein:
the rotor has an axis of rotation,
the first rotor outlet is at a first distance from the axis of rotation, and
the second rotor outlet is at a second distance from the axis of rotation.

12. The filter according to claim 14, wherein the axis of rotation is a substantially horizontal axis.

13. The filter according to claim 10, wherein at least one of the plurality of members has a passage therethrough aligned with and in fluid communication with the first rotor outlet.

14. The filter according to claim 10, including:
another plurality of members disposed in and attached to the rotor,
at least one of the another plurality of members having a passage therethrough defining a first fluid flow path aligned and in fluid communication with the first rotor outlet, and
the plurality of members and the another plurality of members defining a second, serpentine fluid flow path in fluid communication with the second rotor outlet.

15. The filter according to claim 10, including:
a shaft rotatably mounted in the housing and attached to the rotor,
the housing having a third outlet, and
the shaft having a passage therethrough in fluid communication with the first rotor outlet and the third housing outlet.

16. The filter according to claim 10, wherein:
the rotor includes a hollow core with the rotor inlet defined in the core;
the shaft has an outer surface and the core has an inner surface, the inner surface of the core spaced from the outer surface of the shaft to define a passage therebetween in fluid communication with the housing inlet and the rotor inlet.

17. A filter comprising:
a housing having a inlet and a outlet;
a shaft rotatably mounted in the housing;
a rotor including a core disposed about the shaft, a shell connected to the hollow core, an inlet in fluid communication with the housing inlet, and a rotor outlet in fluid communication with the housing outlet,
the core having an outer surface and the shell having an inner surface disposed radially outward from the core;
a first plurality of members attached to the core defining with the outer surface a first plurality of debris collection spaces; and
a second plurality of members attached to the shell and defining with the inner surface a second plurality of debris collection spaces.

18. The filter according to claim 17, wherein the first and second pluralities of members define a serpentine flow path between the rotor and the shaft.

19. The filter according to claim 17, wherein:
the core has a hole formed therethrough that defines the rotor inlet;
the core has an inner surface and the shaft has an outer surface, the inner surface of the core spaced from the outer surface of the shaft to define a first passage therebetween in fluid communication with the housing inlet and the rotor inlet; and
the shaft includes a second passage therethrough in fluid communication with the rotor outlet and the housing outlet.

20. The filter according to claim 17, wherein:
the rotor has an axis of rotation;
the rotor outlet is at a first distance from the axis of rotation;
the rotor has another rotor outlet at a second distance from the axis of rotation, the second distance being greater than the first distance; and
the housing has another housing outlet in fluid communication with the another rotor outlet.

21. The filter according to claim 20, wherein the axis of rotation is a substantially horizontal axis.

22. A method of separating and filtering fluids comprising:
passing a mixture of fluids over a plurality of members;
rotating the plurality of members;
withdrawing a first fluid through a first outlet;
withdrawing a second fluid through a second outlet spaced from the first outlet; and
retaining debris carried by the fluids.

23. The method of claim 22 including rotating the plurality of members about a horizontal axis.

24. The method of claim 22 including passing the first fluid through a passage disposed in at least one of the plurality of the members and in fluid communication with the first outlet.

25. The method of claim 22 including withdrawing the first fluid through a passage disposed centrally through the plurality of members.

26. The method of claim 25 including passing the mixture of fluids through another passage disposed about the passage and through the plurality of members.

27. The method of claim 22 including withdrawing the second fluid through a second outlet spaced radially outwardly from the first outlet.
